(19) United States
(12) Patent Application Publication
(10) Pub. No.: US 2002/0166419 A1
(43) Pub. Date: Nov. 14, 2002

(54) Steering column wrench

(76) Inventor: Kuo Hsiung Lin, Taichung (TW)

Correspondence Address: DOUGHERTY & TROXELL, 5205 LEESBURG PIKE, SUITE 1404, FALLS CHURCH, VA, 22041, US

(21) Appl. No.: 09/851,087

(22) Filed: May 9, 2001

(51) Int. Cl. B25B 13/48

(52) U.S. Cl. 81/436

(57) ABSTRACT

A steering column wrench includes a body having a first eccentric passage for receiving a head of a steering column therein, and a second eccentric passage. A communication hole communicates between the first eccentric passage and the second eccentric passage. The first passage has a knurled inner periphery. A driving member is received in the second eccentric passage and includes an engaging section and a rod which extends eccentrically from an end of the engaging section with which a ratchet tool is connected. The rod has a knurled surface and contacts the head via the communication hole so that when rotating the engaging section, the head clamped between the rod and the first eccentric passage is easily loosened.

### FIELD OF THE INVENTION

The present invention relates to a steering column wrench that has two passages defined eccentrically therein, a head of a steering column and a driving member are respectively received in the two passages. The driving member is rotated by a ratchet tool and rotates the head of the steering column via a communication hole between the two passages.

### BACKGROUND OF THE INVENTION

A conventional steering column wrench is shown in FIGS. 1 and 2 and generally includes a hollow shank 2 and an engaging head 3 is connected to an end of the hollow shank 2. The steering column 1 is received in the hollow shank 2 and a head 100 of the steering column 1 is located outside of the engaging head 3. A position member 4 has an opening 40 and receives the head 100 of the steering column 1 via the opening 40. The position member 4 has two flat surfaces which are matched with two plan surfaces 101. The position member 4 is held and the hollow shank 2 is rotated to loosen the head 100. However, the shapes of the heads 100 of the steering columns 1 of different brands are different so that each brand of the steering column 1 has its specific designed tool to cooperate with. In other words, for the persons who maintain vehicles, have to prepare several sets of different steering column wrenches.

The present invention intends to provide a steering column wrench that is designed to cooperate with different shapes of heads of the steering columns.

### SUMMARY OF THE INVENTION

In accordance with one aspect of the present invention, there is provided a steering column wrench and comprises a body having a first passage and a second passage respectively and eccentrically defined therethrough. A communication hole communicates between the first passage and the second passage. The first passage has a knurled inner periphery and a driving member is received in the second passage. The driving member comprises an engaging section and a rod extending eccentrically from an end of the engaging section. The rod has a knurled surface which contacts the head of a steering column received in the first passage via the communication hole.

The primary object of the present invention is to provide a steering column wrench that is able to deal with different brands of steering columns.

The other object of the present invention is to provide a steering column wrench that is cooperated with a ratchet tool.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a conventional steering column wrench;

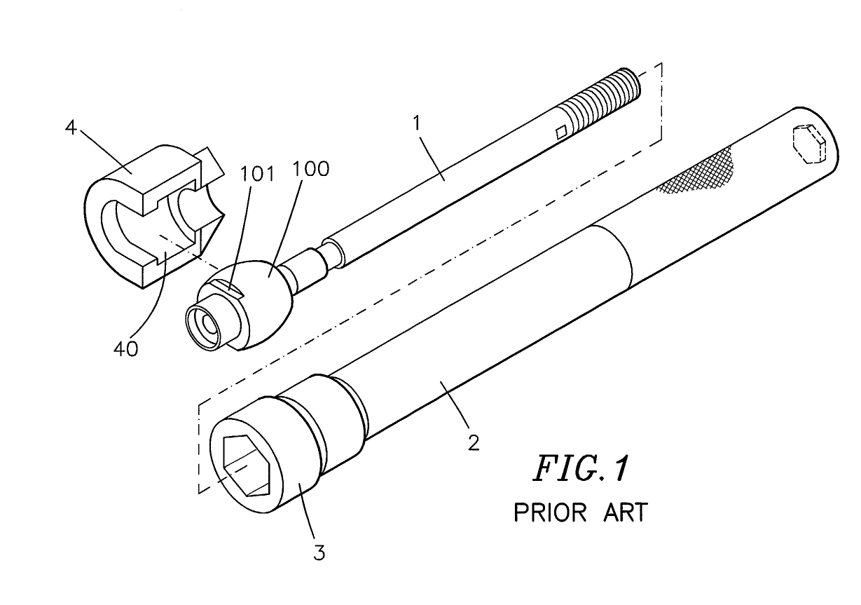

FIG. 2 is a perspective view to show that a steering column is engaged with the conventional steering column wrench;

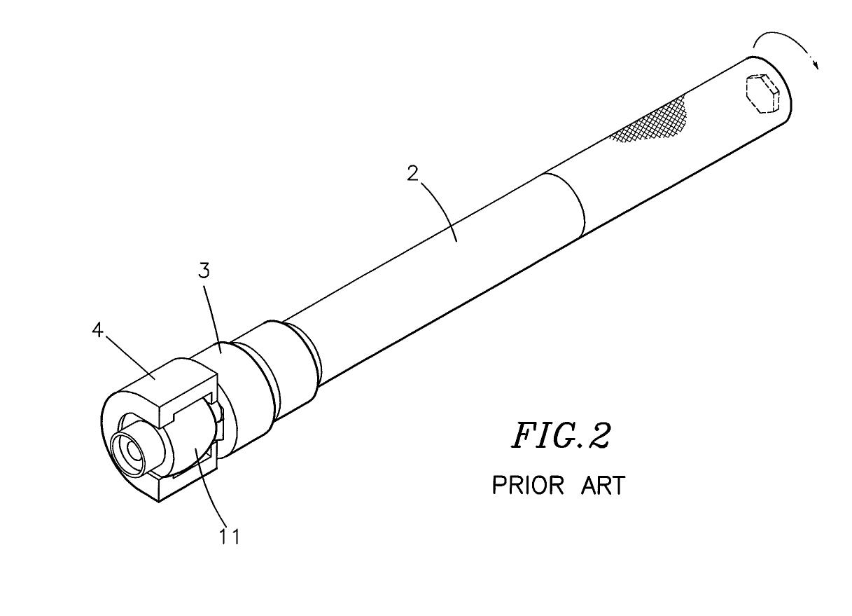

FIG. 3 is an exploded view to show a steering column wrench of the present invention;

FIG. 4 is a cross sectional view to show the steering column wrench of the present invention is connected with a steering column;

FIG. 5 is a perspective view to show the steering column wrench of the present invention is connected with a steering column, and

FIG. 6 is a perspective view to show the steering column wrench of the present invention is cooperated with a ratchet tool.

### DETAILED DESCRIPTION OF THE PREFERRED EMBODIMENT

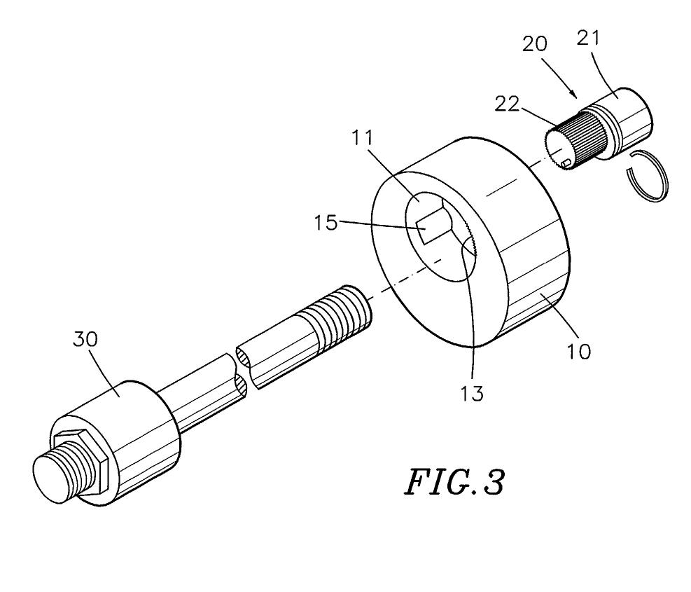

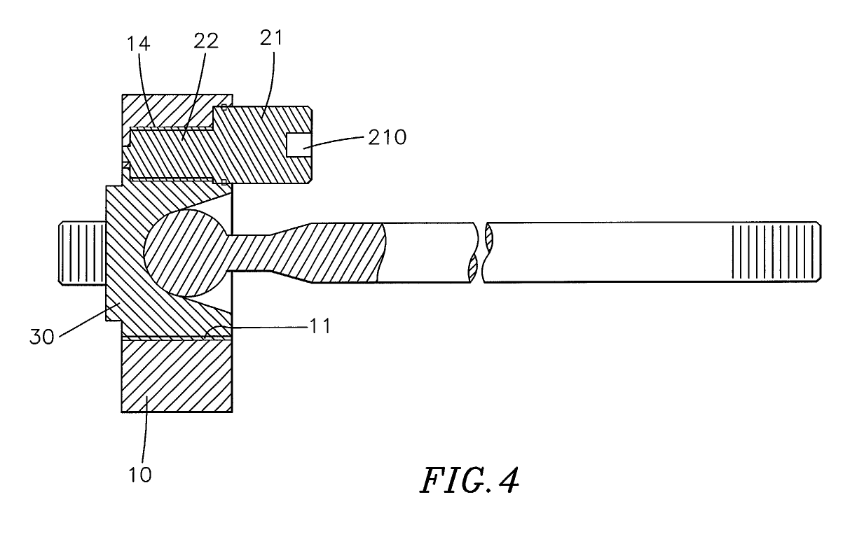

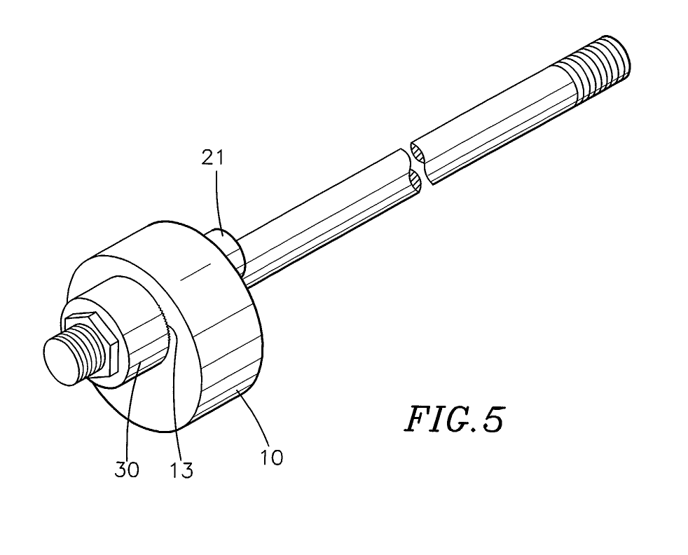

Referring to FIGS. 3 to 5, the steering column wrench of the present invention comprises a body 10 having a first passage 11 and a second passage 14 respectively and eccentrically defined therethrough. A communication hole 15 communicates between the first passage 11 and the second passage 14. The first passage 11 has a knurled inner periphery 13 and a head 30 of a steering column is received in the first passage 11. The head 30 is embraced by the knurled inner periphery 13.

A driving member 20 is received in the second passage 14 and comprises an engaging section 21 and a rod 22 which extends eccentrically from an end of the engaging section 21. The rod 22 has a knurled surface which contacts the head 30 of the steering column via the communication hole 15. A polygonal recess 210 is defined in the other end of the engaging section 21.

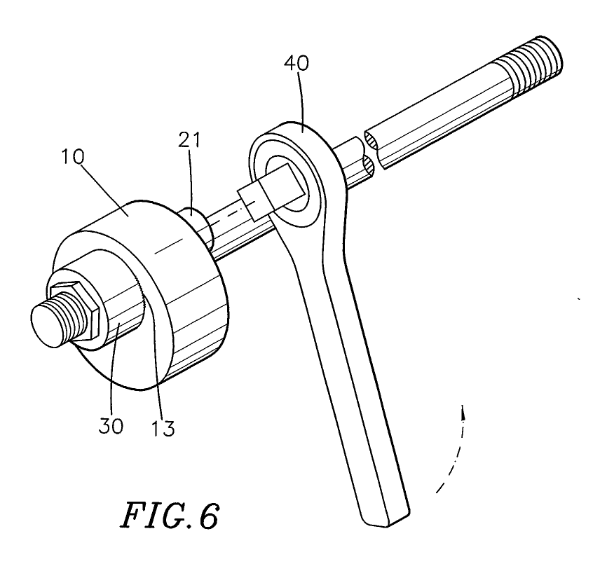

Referring to FIG. 6, a ratchet tool 40 is engaged with the polygonal recess 210 of the engaging section of the driving member 20. When rotating the driving member 20, the head 30 is easily rotated and loosened.

The steering column wrench of the present invention can be used on different shapes of heads of steering columns. A ratchet tool is cooperated with the driving member 20 and can be efficiently rotate the driving member 20.

While we have shown and described the embodiment in accordance with the present invention, it should be clear to those skilled in the art that further embodiments may be made without departing from the scope of the present invention.

What is claimed is:

1. A steering column wrench comprising:
a body having a first passage and a second passage respectively and eccentrically defined therethrough, a communication hole communicating between said first passage and said second passage, said first passage having a knurled inner periphery, and
a driving member received in said second passage and comprising an engaging section and a rod which extends eccentrically from an end of said engaging section, said rod having a knurled surface.

2. The steering column wrench as claimed in claim 1 further comprising a recess defined in the other end of said engaging section.
